(19) United States
(12) Patent Application Publication
(10) Pub. No.: US 2024/0215766 A1
(43) Pub. Date: Jul. 4, 2024

(54) REMOVABLE COOKING VESSEL HEATER SAFETY LOCK SYSTEM WITH STATUS INDICATOR

(71) Applicant: WHIRLPOOL CORPORATION, BENTON HARBOR, MI (US)

(72) Inventors: Samuel J. Bradley, Mundelein, IL (US); Andrew John Leitert, Eau Claire, MI (US); Pravin R. Shewale, Pune (IN); Edward James Haney, St. Joseph, MI (US)

(73) Assignee: WHIRLPOOL CORPORATION, BENTON HARBOR, MI (US)

(21) Appl. No.: 18/396,907

(22) Filed: Dec. 27, 2023

Related U.S. Application Data
(60) Provisional application No. 63/477,473, filed on Dec. 28, 2022.

(51) Int. Cl. A47J 43/07; A47J 27/00; A47J 43/046

(52) U.S. Cl. CPC A47J 43/0761; A47J 27/004; A47J 43/046; A47J 43/0727; A47J 2202/00

(57) ABSTRACT

A food processing appliance includes a base and a heating component operably connected to the base and configured to selectively receive a vessel and generate heat above a temperature threshold. At least one latch includes a locked position that secures the heating component to the vessel and an unlocked position that permits removal of the heating component from the vessel. A temperature dependent catch assembly is configured to retain the at least one latch in the locked position above the temperature threshold and release the at least one latch below the temperature threshold.

### CROSS-REFERENCE TO RELATED APPLICATION

This application claims priority to and the benefit under 35 U.S.C. § 119(e) of U.S. Provisional Application No. 63/477,473, filed on Dec. 28, 2022, entitled “REMOVABLE COOKING VESSEL HEATER SAFETY LOCK SYSTEM WITH STATUS INDICATOR,” the disclosure of which is hereby incorporated herein by reference in its entirety.

### BACKGROUND OF THE DISCLOSURE

The present disclosure generally relates to a food processing appliance, and, more specifically, to a food processing appliance with a heating component and a temperature dependent catch assembly.

### SUMMARY OF THE DISCLOSURE

According to one aspect of the present disclosure, a food processing appliance includes a base. A heating component operably connects to the base and is configured to selectively receive a vessel and generate heat above a temperature threshold. At least one latch includes a locked position that secures the heating component to the vessel and an unlocked position that permits removal of the heating component from the vessel. A temperature dependent catch assembly is configured to retain the at least one latch in the locked position above the temperature threshold and release the at least one latch below the temperature threshold.

According to another aspect of the present disclosure, a food processing appliance includes a base. A heating component is located in a housing and operably connects to the base and is configured to selectively receive a vessel and generate heat above a temperature threshold. latch includes a locked position that secures the heating component to the vessel and an unlocked position that permits removal of the heating component from the vessel. A temperature dependent catch assembly includes a wire at least partially formed of a shape-memory alloy and a pivot member. The wire compresses above the temperature threshold moving the pivot member to an articulated position in order to push the latch into the locked position and decompress below the temperature threshold to return the pivot member to a non-articulated position and release the latch below the temperature threshold.

According to yet another aspect of the present disclosure, a food processing appliance includes a base. A heating component is located in a housing and operably connects to the base and is configured to selectively receive a vessel and generate heat above a temperature threshold. latch includes a locked position that secures the heating component to the vessel and an unlocked position that permits removal of the heating component from the vessel. A temperature dependent catch assembly includes a wire formed as a closed loop that is at least partially formed of a shape-memory alloy that compresses above the temperature threshold and decompresses below the temperature threshold. A carrier includes an outer surface that is rounded and defines a track with the wire located in the track. A pivot member includes a boot, the pivot member is pivotally coupled to the carrier with a first pivot joint and the housing with a second pivot joint. The pivot member includes an articulated position when the wire is compressed where the boot pushes the latch in the locked position and an unarticulated position when the wire is decompressed and the latch is released from the locked position.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side elevational view of a food processing appliance according to an aspect of the present disclosure;

FIG. 2 is a side cross-sectional view of a food processing appliance according to an aspect of the present disclosure;

FIG. 3 is a side cross-sectional view of a heating component and a base of a food processing appliance in a disassembled condition according to an aspect of the present disclosure;

FIG. 4 is a side cross-sectional view of a food processing appliance with a heating component and a vessel according to an aspect of the present disclosure;

FIG. 5 is an enlarged side cross-sectional view of a food processing appliance with a heating component and a vessel in an unlocked position according to an aspect of the present disclosure;

FIG. 6 is an enlarged side cross-sectional view of a food processing appliance with a heating component and a vessel in a locked position according to an aspect of the present disclosure;

FIG. 7 is a top perspective view of a partially disassembled heating component according to an aspect of the present disclosure;

FIG. 8 is a top perspective view of a partially disassembled latch and housing of a heating component according to an aspect of the present disclosure; and

FIG. 9 is a side cross-sectional view of a food processing appliance with an indicator component according to an aspect of the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to a food processing appliance with a heating component and a temperature dependent catch assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

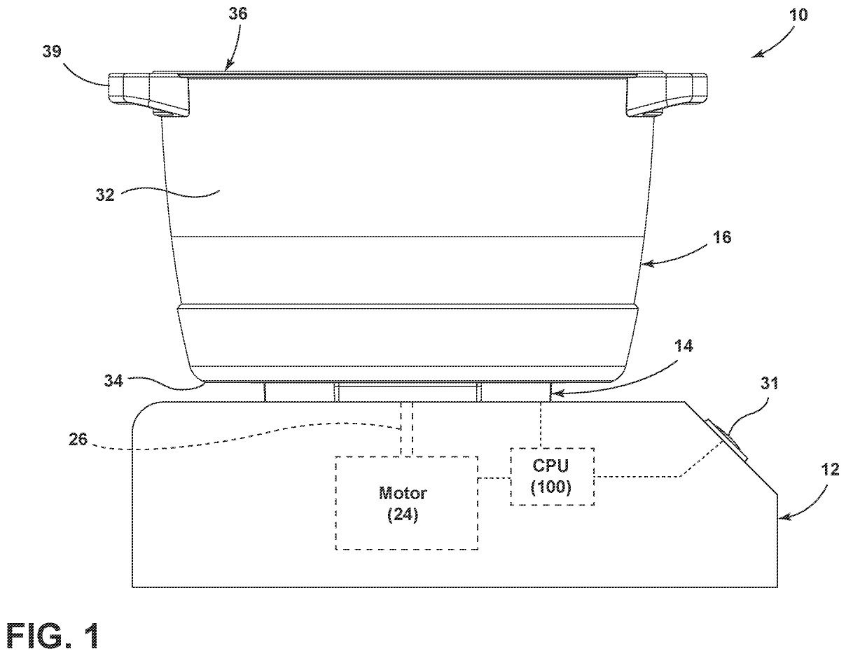

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

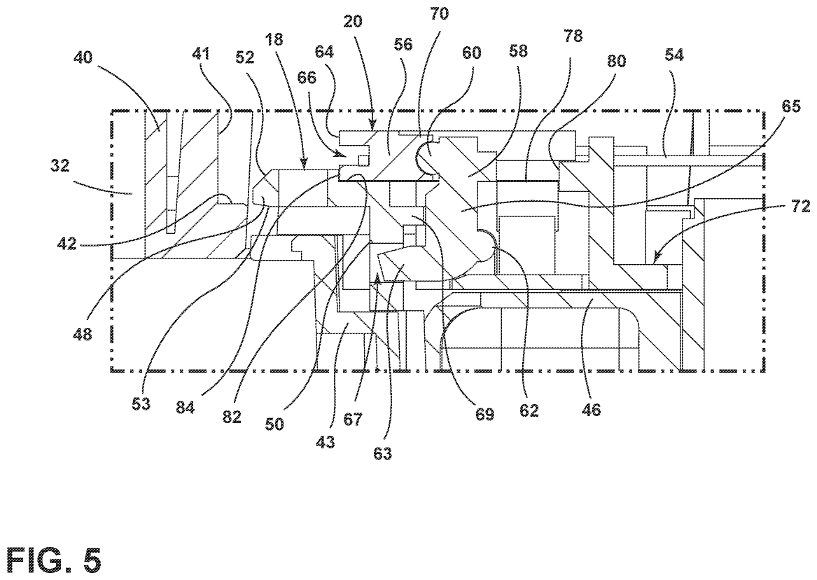

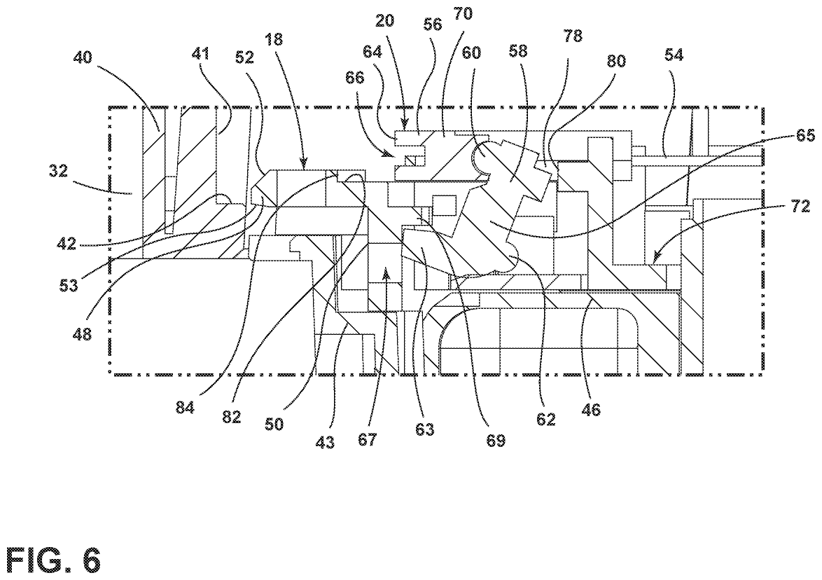

Referring to FIGS. 1-8, reference numeral 10 generally designates a food processing appliance. The food processing appliance 10 includes a base 12 and a heating component 14 operably connected to the base 12 and configured to selectively receive a vessel 16 and generate heat above a temperature threshold. At least one latch 18 includes a locked position (FIG. 6) that secures the heating component 14 to the vessel and an unlocked position (FIG. 5) that permits removal of the heating component 14 from the vessel 16. A temperature dependent catch assembly 20 is configured to retain the at least one latch 18 in the locked position above the temperature threshold and release the at least one latch 18 below the temperature threshold.

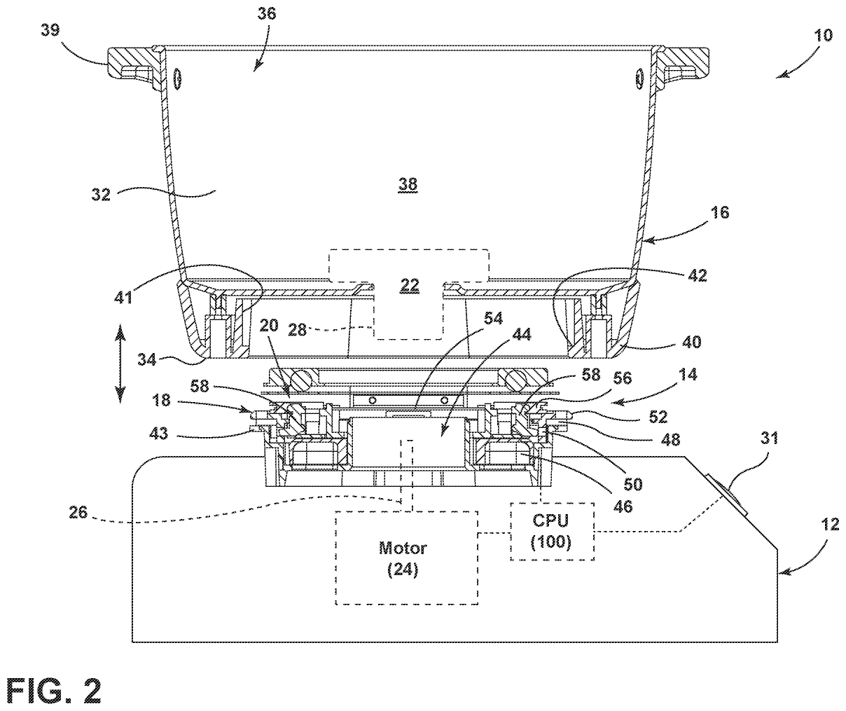

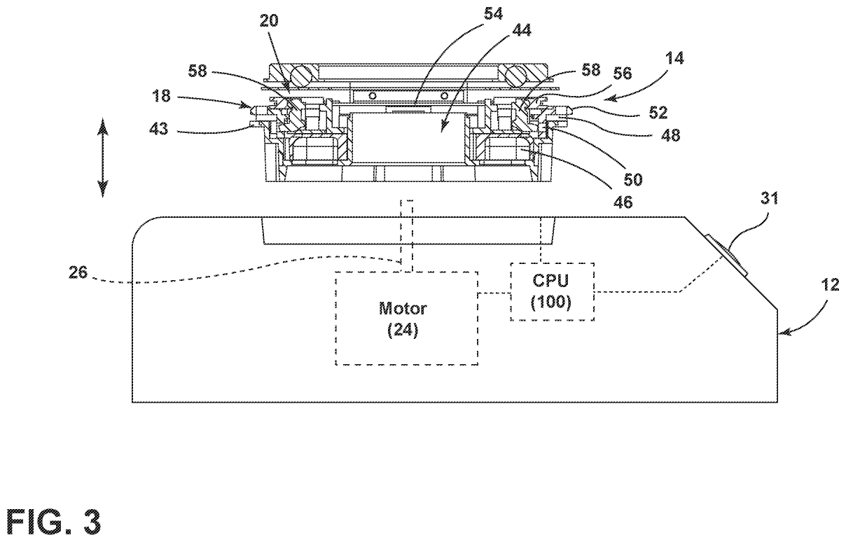

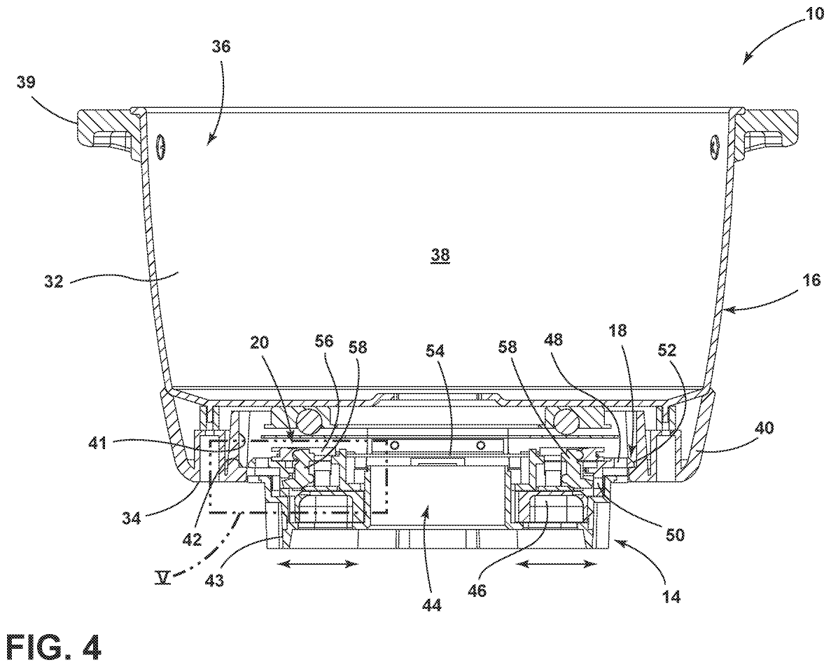

With reference now to FIGS. 1-3, the temperature threshold may correspond to a temperature that can create discomfort to human skin. For example, the temperature threshold may be about 100° Fahrenheit or more, for example, about 105° Fahrenheit or more, or between about 100° Fahrenheit and about 110° Fahrenheit. In this manner, the catch assembly 20 is configured to prevent discomfort to a user and/or prevent burning of a kitchen countertop when the vessel 16 and/or heating component 14 is removed and placed thereon. The heating component 14 may be integral (e.g., permanently connected) to the base 12, removably connected to the base 12 (FIGS. 3 and 4), integral with the vessel 16 (FIG. 4), or removably connected to the vessel 16 (FIG. 2). In some embodiments, the heating component 14 is removably connected to the base 12 and the vessel 16 (FIG. 3). The at least one latch 18 may, therefore, selectively connect the heating component 14 to the base 12 and/or the vessel 16, and the catch assembly 20 prevents movement of the at least one latch 18 above the temperature threshold. Therefore, it should be appreciated that the principle operation of the at least one latch 18 and catch assembly 20 may be applied to various coupling configurations of the base 12, the vessel 16, and the heating component 14. More particularly, the latch 18 and catch assembly 20 may prevent movement of the vessel 16 relative to the heating component 14 or the base 12 relative to the heating component 14. In addition to heating food within the vessel 16, the vessel 16 may include a variety of tools 22 (FIG. 2) that process the food contents in the vessel 16. For example, the vessel 16 may be configured as a blender and the tool 22 may include blending blades rotatable within the vessel 16.

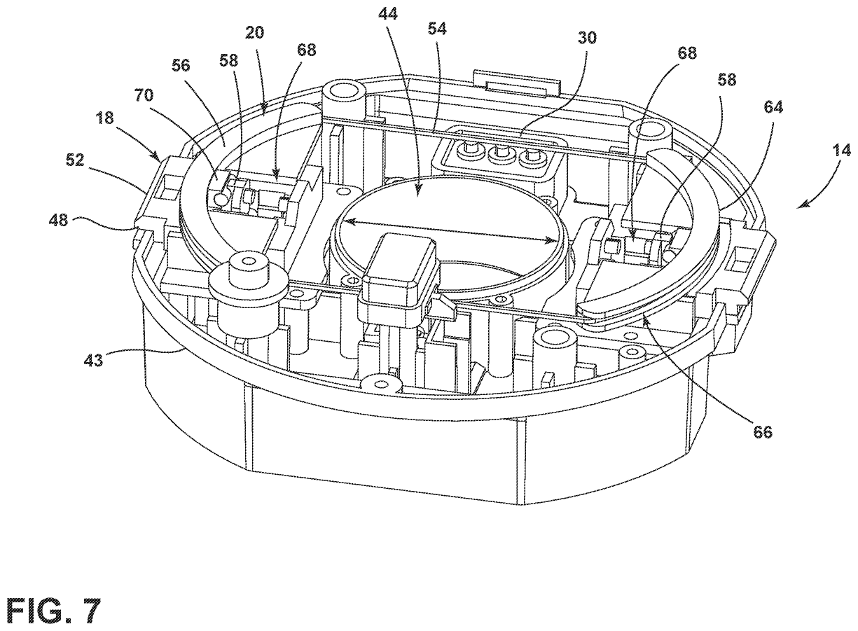

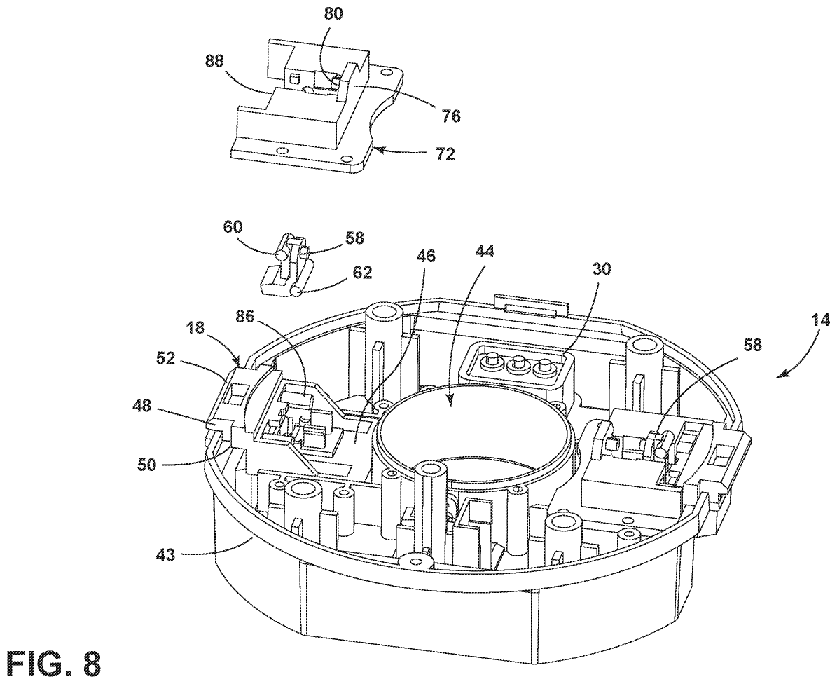

With continued reference to FIGS. 1-3, in some embodiments, the heating component 14 is selectively connected to the vessel 16 with the at least one latch 18. The base 12 may include a motor 24, and a control system 100 is operably connected to the motor 24. The motor 24 is configured to rotatably power a drive mechanism or output drive hub 26, which, in turn, rotatably drives the tool 22. The tool 22 may connect to the output drive hub 26 via an input drive hub 28 (FIG. 2). An electrical connection 30 (FIGS. 7 and 8) may connect the base 12 to the heating component 14. A user interface 31 may be operably connected to the control system 100 for selecting user options relating to the processing functionality (e.g., warming the heating component 14 and functionalities associated with the tool 22). The vessel 16 may include a vessel body 32 extending between a bottom surface 34 and a top opening 36 to define a cavity 38 (FIG. 2). A handle 39 may be connected to the vessel body 32 to facilitate moving the vessel 16 on and off the base 12, the heating component 14, and/or around a kitchen environment. The bottom surface 34 defines an annular sidewall 40 including an interior surface 41 defining at least one ridge 42 for connecting to the at least one latch 18 (FIG. 2).

With reference now to FIGS. 2-6, the heating component 14 includes a housing 43 defining a central aperture 44 for permitting the output drive hub 26 and/or the input drive hub 28 to extend at least partially therethrough and operably connect. The at least one latch 18 may include, one, two, i.e., a first and a second latch 18, or more latches 18. The latches 18 may be diametrically opposed. More particularly, the housing 43 may be generally cylindrically shaped and the first latch 18 may be located on an opposite side than the second latch 18. As best illustrated in FIGS. 5 and 6, each latch 18 includes a latch body 46, a latch interface head 48, and a latch neck 50 extending between the latch body 46 and the latch interface head 48. Each latch 18 may be slidable within the housing 43 between the unlocked position and the locked position as indicated by the arrows in FIG. 4. More particularly, the latch 18 may slide outwardly (e.g., in a direction towards on outer perimeter of the housing 43) to enter the locked position. The latch interface head 48 includes an angled top surface 52 to facilitate inward movement as a result of downward pressure from the annular sidewall 40 of the vessel 16. Likewise, the latch interface head 48 may include an angled bottom surface 53 to facilitate connection to the at least one ridge 42. While not explicitly shown, the at least one ridge 42 may be located in discrete locations around the interior surface 41 and equal in number to the latches 18 or, alternatively, may be formed as an annular step extending around the entire interior surface 41 of the annular sidewall 40 on the vessel 16.

With reference now to FIGS. 4-7, the temperature dependent catch assembly 20 may be at least partially formed of a shape-memory alloy. More particularly, the temperature dependent catch assembly 20 includes a wire 54 formed of a shape-memory alloy that compresses above the temperature threshold and decompresses below the temperature threshold. The wire 54 wraps at least partially around at least one carrier 56 that moves in response to the compression and decompression of the wire 54. The at least one carrier 56 may include a pair of diametrically opposed carriers including a first and second carrier 56. Generally, the number of carriers 56 may be equal to or less than the number of latches 18 as, during operation, the carrier 56 facilitates movement of the latches 18. Stated another way, each one of the latches 18 may be operably connected to one of the carriers 56.

With reference now to FIGS. 5 and 6, each latch 18 may be operably connected to an associated carrier 56 with a pivot member 58. The pivot members 58 each include a first pivot joint 60 pivotally connected to the carrier 56 and a second pivot joint 62 pivotally coupled to the housing 43. The pivot members 58 each also include a boot 63 that, when articulated by energy from the compression, pushes an associated latch 18 outwardly upon pivotal moment in a first direction until the angled bottom surface 53 of the latch interface head 48 extends over the at least one ridge 42. More particularly, as the heating component 14 reaches above the temperature threshold, the wire 54 compresses and moves the carriers 56 towards one another to cause the pivot members 58 to pivotally move (i.e., articulate) in the first direction thereby pushing both latches 18 outwardly into engagement with the at least one ridge 42. The pivot member 58 includes a pivot member body 65 that extends from the first pivot joint 60 to the boot 63. In some embodiments, the latch 18 includes a boot aperture 67 that accommodates the boot 63 in a non-articulated position (FIG. 5). A latch tab 69 may be located over the boot aperture 67. In such embodiments, as the pivot member 58 is moved to an articulated position (FIG. 6), the pivot member body 65 initially pushes against the latch tab 69, moving the latch 18 until the boot 63 can articulate out of the boot aperture 67 and into pushing engagement against the latch tab 69 or a proximate surface of the latch 18.

With reference now to FIGS. 7 and 8, each carrier 56 includes an outer surface 64 defining a track 66. The wire 54 may be configured as a ring-shaped band or closed loop that is retained within each track 66. The wire 54 may be assembled in a closed loop or otherwise include ends that are otherwise fused, tied, and/or the like to form the closed loop. In some embodiments, the carriers 56 and/or latches 18 may be biased outwardly by a spring member (not shown), such that the latches 18 are biased into the unlocked position when the wire 54 is below the temperature threshold. The biasing force of the spring member is overcome when the wire 54 is compressed as a result of exposure to the temperature threshold. Each carrier 56 may define a bay 68 (FIG. 7) with a first pivot connection 70 engaged with the first pivot joint 60. The first pivot connection 70 may be engaged with the first pivot joint 60 within the bay 68 and substantially aligned with the wire 54, such that the force of the wire 54 is directly imparted on the first pivot joint 60.

With reference now to FIG. 8, the housing 43 includes at least one retainer plate 72 (e.g., an equal number of retainer plates 72 to latches 18) that includes a bridge portion 76 that extends over the latch 18 (e.g., a pair of retainer plates 72 for each latch 18). The bridge portion 76 defines a first cam surface 78 (FIG. 5) having a first abutment step 80 and the latch 18 defines a second cam surface 82 defining a second abutment step 84 (FIG. 5). The first and second cam surfaces 78, 82 are located between the first and second abutment steps 80, 84 and define space for the carrier 56 to travel between the compressed and decompressed conditions. The latch 18 includes a pair of posts 86, and the retainer plate 72 includes a pair of post receiving chambers 88 that slideably receive the posts 86 and guide relative movement between the latch 18 and the retainer plate 72. More particularly, the retainer plate 72 may be statically coupled to the housing 43 and the latch associated with the retainer plate 72 may travel relative thereto. In some embodiments, the second pivot joint 62 pivotally connected to the retainer plate 72.

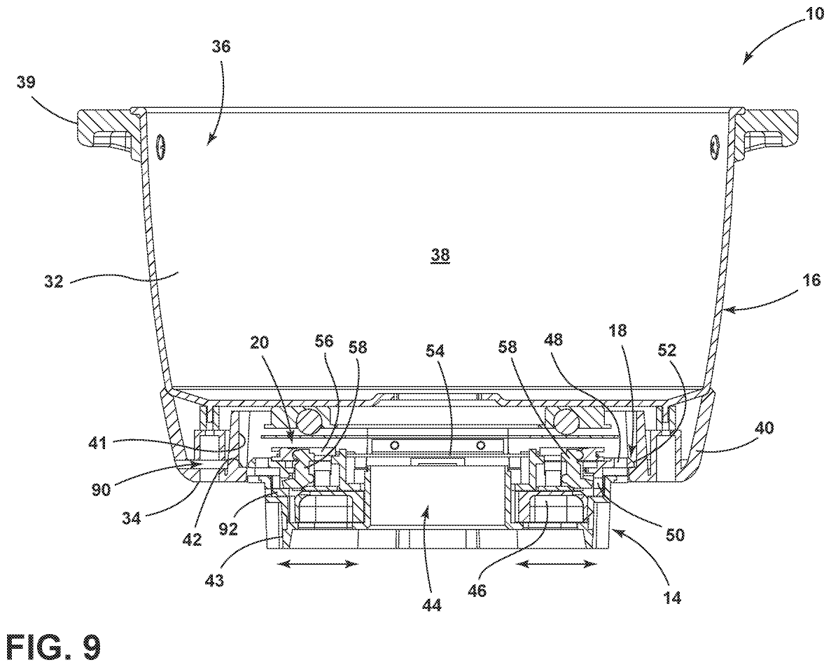

With reference now to FIG. 9, the food processing appliance 10 may include an indicator component that is configured to notify a user when the vessel 16 and/or heating component 14 can be removed (i.e., once the heating component 14 and/or wire 54 is below the temperature threshold). In some embodiments, the indicator component may include a window 90 that allows a user to view the position of the latch 18, the pivot member 58, the carrier 56, or other components of the food processing appliance 10 that move as a result of compression and decompression of the wire 54. In some embodiments, the viewable component is color coded. For example, a first color indicia on the viewable component may be visible when the latch 18 is in the unlocked position and a second color indicia on the viewable component may be visible when the latch 18 is in the locked position. In still further embodiments, a light, such as a light-emitting diode (LED) may be located on the viewable component and only visible in one of the locked and unlocked positions. In some embodiments, the indicator component may be a physical structure, such as an indicator member 92 that is connected to the heating component 14 and moves into user visibility during the compression and decompression of the wire 54 to notify a user if the latch 18 is retained or released by the catch assembly 20 (i.e., if the latch is in the locked or unlocked position). In some embodiments, the indicator member 92 may extend out of a through hole in the housing 43 in one of the locked or the unlocked positions and retract back into the through hole in the other of the locked or unlocked positions. In still further embodiments, the indicator member 92 may include a color indicia or a light that becomes visible during movement of the latch 18 between positions. In still further embodiments yet, the indicator member 92 may be physically connected to the previously described viewable component and is visible through the window 90. The indicator component may of the afore-described examples may be configured to notify a user of the latch 18 (i.e., locked and unlocked position) or the position of other components such as the pivot member 58 or the carrier 56 that move as a result of compression and decompression of the wire 54.

The disclosure is further summarized in the following paragraphs and is further characterized by combinations of any and all of the various aspects described therein.

According to one aspect of the present disclosure, a food processing appliance includes a base. A heating component operably connects to the base and is configured to selectively receive a vessel and generate heat above a temperature threshold. At least one latch includes a locked position that secures the heating component to the vessel and an unlocked position that permits removal of the heating component from the vessel. A temperature dependent catch assembly is configured to retain the at least one latch in the locked position above the temperature threshold and releases the at least one latch below the temperature threshold

According to another aspect, a temperature dependent catch assembly is at least partially formed of a shape-memory alloy.

According to yet another aspect, a temperature dependent catch assembly includes a wire configured to compress above a temperature threshold and decompress below the temperature threshold.

According to still yet another aspect, a wire wraps at least partially around at least one carrier that moves in response to the compression and decompression of the wire and an at least one latch is operably connected to the at least one carrier.

According to another aspect of the present disclosure, at least one latch is slidable between a locked position and an unlocked position.

According to yet another aspect of the present disclosure, a carrier defines a track and a wire is located in the track.

According to still another aspect, at least one carrier includes a first carrier and a second carrier in an opposing relationship and at least one latch includes a first latch connected to the first carrier and a second latch connected to the second carrier.

According to another aspect, an indicator member is connected to a heating component and is configured to move during the compression and decompression of a wire to notify a user if a latch is retained or released by a temperature dependent catch assembly.

According to yet another aspect, a vessel includes a processing tool configured to be driven by a base.

According to another aspect of the present disclosure, a food processing appliance includes a base. A heating component is located in a housing and operably connects to the base and is configured to selectively receive a vessel and generate heat above a temperature threshold. latch includes a locked position that secures the heating component to the vessel and an unlocked position that permits removal of the heating component from the vessel. A temperature dependent catch assembly includes a wire at least partially formed of a shape-memory alloy and a pivot member. The wire compresses above the temperature threshold moving the pivot member to an articulated position in order to push the latch into the locked position and decompress below the temperature threshold to return the pivot member to a non-articulated position and release the latch below the temperature threshold.

According to another aspect, a latch is slideably located in a retainer plate, the retainer plate defines one of a post or a post receiving chamber and the latch includes the other of the post or the post receiving chamber.

According to yet another aspect, a retainer plate is statically coupled to a housing.

According to still yet another aspect, a wire is operably connected to a carrier that includes an outer surface that is rounded defining a track and a wire is located in the track.

According to another aspect, an inner surface of a carrier defines a first pivot connection and a pivot member includes a first pivot joint pivotally connected to the first pivot connection.

According to yet another aspect, a pivot member further includes a second pivot joint pivotally connected to a housing.

According to still yet another aspect, a pivot member includes a boot extending towards a latch that pushes the latch into a locked position when the pivot member is in an articulate position.

According to another aspect, a housing defines a window to a latch for notifying a user that the latch is in an unlocked position.

According to yet another aspect of the present disclosure, a food processing appliance includes a base. A heating component is located in a housing and operably connects to the base and is configured to selectively receive a vessel and generate heat above a temperature threshold. latch includes a locked position that secures the heating component to the vessel and an unlocked position that permits removal of the heating component from the vessel. A temperature dependent catch assembly includes a wire formed as a closed loop that is at least partially formed of a shape-memory alloy that compresses above the temperature threshold and decompresses below the temperature threshold. A carrier includes an outer surface that is rounded and defines a track with the wire located in the track. A pivot member includes a boot, the pivot member is pivotally coupled to the carrier with a first pivot joint and the housing with a second pivot joint. The pivot member includes an articulated position when the wire is compressed where the boot pushes the latch in the locked position and an unarticulated position when the wire is decompressed and the latch is released from the locked position.

According to another aspect, an indicator member is connected to a heating component and is configured to move during the compression and decompression of a wire to notify a user if a latch is retained or released by a temperature dependent catch assembly.

According to yet another aspect, a housing defines a window to a latch for notifying a user that the latch is in an unlocked position.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A food processing appliance comprising:
a base;
a heating component operably connected to the base and configured to selectively receive a vessel and generate heat above a temperature threshold;
at least one latch including a locked position that secures the heating component to the vessel and an unlocked position that permits removal of the heating component from the vessel; and
a temperature dependent catch assembly configured to retain the at least one latch in the locked position above the temperature threshold and release the at least one latch below the temperature threshold.

2. The food processing appliance of claim 1, wherein the temperature dependent catch assembly is at least partially formed of a shape-memory alloy.

3. The food processing appliance of claim 2, wherein the temperature dependent catch assembly includes a wire configured to compress above the temperature threshold and decompress below the temperature threshold.

4. The food processing appliance of claim 3, wherein the wire wraps at least partially around at least one carrier that moves in response to the compression and decompression of the wire and the at least one latch is operably coupled to the at least one carrier.

5. The food processing appliance of claim 4, wherein the at least one latch is slidable between the locked position and the unlocked position.

6. The food processing appliance of claim 4, wherein the at least one carrier defines a track and the wire is located in the track.

7. The food processing appliance of claim 4, wherein the at least one carrier includes first carrier and a second carrier in an opposing relationship and the at least one latch includes a first latch operably coupled to the first carrier and a second latch operably coupled to the second carrier.

8. The food processing appliance of claim 3, wherein an indicator member is coupled to the heating component and is configured to move during the compression and decompression of the wire to notify a user if the at least one latch is retained or released by the temperature dependent catch assembly.

9. The food processing appliance of claim 1, wherein the vessel includes a food processing tool configured to be driven by the base.

10. A food processing appliance comprising:
a base;
a heating component located in a housing and operably connected to the base and configured to selectively receive a vessel and generate heat above a temperature threshold;
a latch including a locked position that secures the heating component to the vessel and an unlocked position that permits removal of the heating component from the vessel; and
a temperature dependent catch assembly including a wire at least partially formed of a shape-memory alloy and a pivot member, the wire compresses above the temperature threshold moving the pivot member to an articulated position in order to push the latch into the locked position and decompress below the temperature threshold to return the pivot member to a non-articulated position and release the latch below the temperature threshold.

11. The food processing appliance of claim 10, wherein the latch is slideably located in a retainer plate, the retainer plate defining one of a post or a post receiving chamber and the latch including the other of the post or the post receiving chamber.

12. The food processing appliance of claim 11, wherein the retainer plate is statically coupled to the housing.

13. The food processing appliance of claim 10, wherein the wire is operably connected to a carrier that includes an outer surface that is rounded defining a track and the wire is located in the track.

14. The food processing appliance of claim 13, wherein an inner surface of the carrier defines a first pivot connection and the pivot member includes a first pivot joint pivotally connected to the first pivot connection.

15. The food processing appliance of claim 14, wherein the pivot member further includes a second pivot joint pivotally connected to the housing.

16. The food processing appliance of claim 15, wherein the pivot member further includes a boot extending towards the latch that pushes the latch into the locked position when the pivot member is in the articulate position.

17. The food processing appliance of claim 10, wherein the housing defines a window to the latch for notifying a user that the latch is in the unlocked position.

18. A food processing appliance comprising:
a base;
a heating component located in a housing and operably connected to the base and configured to selectively receive a vessel and generate heat above a temperature threshold;
a latch including a locked position that secures the heating component to the vessel and an unlocked position that permits removal of the heating component from the vessel; and
a temperature dependent catch assembly comprising:
a wire formed as a closed loop that is at least partially formed of a shape-memory alloy and compresses above the temperature threshold and decompresses below the temperature threshold;
a carrier including an outer surface that is rounded and defines a track with the wire located in the track;
a pivot member including a boot, the pivot member pivotally coupled to the carrier with a first pivot joint and the housing with a second pivot joint, the pivot member including an articulated position when the wire is compressed where the boot pushes the latch in the locked position and an unarticulated position when the wire is decompressed and the latch is released from the locked position.

19. The food processing appliance of claim 18, wherein an indicator member is connected to the heating component and is configured to move during the compression and decompression of the wire to notify a user if the latch is retained or released by the temperature dependent catch assembly.

20. The food processing appliance of claim 18, wherein the housing defines a window to the latch for visually notifying a user that the latch is in the unlocked position.
